(19) United States
(12) Patent Application Publication
(10) Pub. No.: US 2020/0220994 A1
(43) Pub. Date: Jul. 9, 2020

(54) IMAGE FORMING APPARATUS AND PROGRAM

(71) Applicant: Konica Minolta Inc., Tokyo (JP)

(72) Inventor: KEISHI SAKUMA, Tokyo (JP)

(21) Appl. No.: 16/702,645

(22) Filed: Dec. 4, 2019

(30) Foreign Application Priority Data
Jan. 4, 2019 (JP) 2019-000100

(51) Int. Cl. H04N 1/44; H04N 1/00; G06F 3/12

(52) U.S. Cl. CPC H04N 1/4426; G06F 3/1246; G06F 3/1205; H04N 1/0048

(57) ABSTRACT

An image forming apparatus includes: a restriction information acquisition part that acquires print function restriction information corresponding to a user; a document acquisition part that acquires an HTML document from a Web server; a print command receiver that receives a print command; an analyzer that analyzes whether designated print setting information is included in the HTML document; a print setting determination part, in which in a case where an analysis result indicates that the designated print setting information is included in the HTML document, the print setting determination part determines, in accordance with the designated print setting information, a print setting, and in a case where an analysis result indicates that the designated print setting information is not included in the HTML, document, the print setting determination part determines the print setting in accordance with the print-function restriction information; and a print execution part that prints the print object.

The entire disclosure of Japanese patent Application No. 2019-000100, filed on Jan. 4, 2019, is incorporated herein by reference in its entirety.

### BACKGROUND

### Technological Field

The present invention relates to an image forming apparatus and a program capable of restricting a print function per user.

### Description of the Related Art

In an image forming apparatus capable of restricting a print function per user, following restrictions can be set per user, for example: whether to restrict color printing; whether to prohibit single-sided printing and enforce double-sided printing; and whether to restrict the number of printable sheets. The content of such restrictions is normally set per user by an administrator, and each user can utilize functions of the image forming apparatus only within a range of print function restriction set by the administrator. For example, the print-function restriction that enforces use of the double-sided printing is important to manage a printing cost. Therefore, a user cannot release the print-function restriction without permission, and a predetermined procedure is required to obtain permission of the administrator even for temporary release.

JP 2007-193432 A discloses a printing system that simplifies management of print-function restriction per user. In this printing system, current restriction release information per user is generated based on: print setting information restricted per user; and restriction release information generated by operation of an administrator, and a print setting enforcing condition at the time of execution of the printing by each user is determined in accordance with such restriction release information.

JP 2011-198376 A discloses an image forming apparatus having functions to: download a file linked to a Web page displayed by accessing a Web server; and print or store the file in accordance with a user's selection received on a selection screen. In this image forming apparatus, whether the file is permitted to be printed is determined, by referring to attribute information of the downloaded file or HTML information of the Web page. In a case where the file is not permitted to be printed, a print button is not displayed on a selection screen.

When a specific document is printed, there is a case where it is necessary to use a function currently under print-function restriction. For example, such a case may include cases of: printing an application document required to be printed out with a specific print setting; printing a certificate or the like including a seal or a photograph in a document; and the like. In the case of such a document, it is not preferable that the print-function restriction set per user disables printing with a print setting required for the document, and the document should be printed with a print setting designated by a document issuer or a document recipient.

However, in a conventional image forming apparatus in which print-function restriction is set per user, print-function restriction per user works even in the case of printing the above-described document (document that should be constantly printed with the specific print setting regardless of who a user is). Therefore, to properly print the document with the print setting designated by the document issuer or the document recipient, it is necessary to perform, between each user and, an administrator, a procedure to release the print-function restriction every time.

In the printing system disclosed in JP 2007-193432 A, it is still necessary to perform a predetermined procedure between each user and the administrator (procedure to change restriction release information generated by operation of the administrator) in order to release the print-function restriction, and the above-described problem is not solved.

Also, JP 2011-198376 A is a technology relating to print permission/non-permission in a case of downloading and printing a file linked to a Web page, by which it is not possible to easily release the print-function restriction per user.

### SUMMARY

The present invention is intended to solve the above-described problems, and is directed to providing an image forming apparatus and a program capable of simply releasing print-function restriction per user to print a specific document that is to be printed with a print setting designated by a document issuer.

To achieve the abovementioned object, according to an aspect of the present invention, an image forming apparatus reflecting one aspect of the present invention comprises: a restriction information acquisition part that acquires print-function restriction information corresponding to a user; a document acquisition part that acquires an HTML document from a Web server; a print command receiver that receives a print command in which an HTML document acquired by the document acquisition part or a file linked to the HTML document is set as a print object; au analyzer that analyzes whether designated print setting information is included in the HTML document, the designated print setting information providing a command to print, with a predetermined print setting, the print object associated with the print command; a print setting determination part, in which in a case where an analysis result of the analyzer indicates that the designated print setting information is included in the HTML document, the print setting determination part determines. In accordance with the designated print setting information, a print selling at the lime of printing the print object associated with the print command, and in a case where an analysis result of the analyzer indicates that the designated print setting information is not included in the HTML document, the print setting determination part determines the print setting in accordance with the print-function restriction information corresponding to the user; and a print execution part that prints, in accordance with the print setting determined by the print setting determination part, the print object for which the print command has been received.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration and a connection environment of an image forming apparatus according to an embodiment of the present invention;

FIG. 2 is a diagram illustrating a print sequence in a case where designated print setting information is included in an HTML document:

FIG. 3 is a diagram illustrating a print sequence in a case where the designated print setting information is not included in an HTML document;

FIG. 4 is a flowchart illustrating HTML analysis processing performed by an analyzer according to a first embodiment;

FIG. 5 is a flowchart illustrating print setting defining processing performed by a print setting determination part;

FIG. 6 is a diagram illustrating a print sequence in a case where a number-of-print-sheet restricting function is enabled;

FIG. 7 is a diagram illustrating a print sequence in a case where the number-of-print-sheet restricting function is disabled;

FIG. 8 is a flowchart illustrating a count necessity determination processing performed by a print setting determination part;

FIG. 9 is a flowchart illustrating HTML analysis processing performed by an analyzer according to a second embodiment; and

FIG. 10 is a flowchart illustrating HTML analysis processing performed by an analyzer according to a third embodiment.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

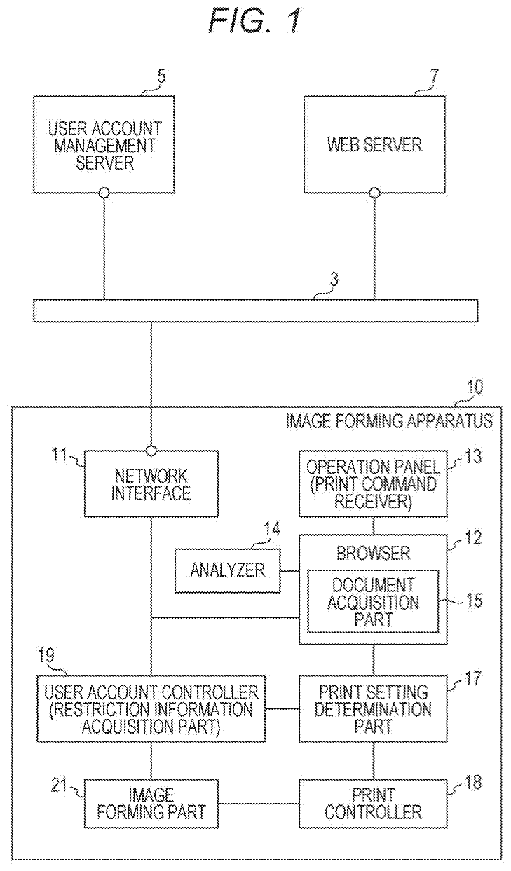

FIG. 1 is a diagram illustrating a schematic configuration and a connection environment of an image forming apparatus 10 according to an embodiment of the present invention. The image forming apparatus 10 is connected to a network 3 such as a local area network (LAN). The network 3 has a user account management server 5 and a Web server 7 connected.

The image forming apparatus 10 has a function of displaying and printing an HTML document acquired by accessing the Web sever 7 in addition to a function of executing printing based on a print job received from a personal computer (PC) (not illustrated) connected to the network 3. Furthermore, the image forming apparatus 10 has a print-function restriction function that restricts, in accordance with print function restriction information per user, a print function and enforces use of a specific function when a certain user uses the print function. More specifically, permission for use, prohibition of use, and enforced use of a function owned by the image forming apparatus 10 are executed in accordance with the print-function restriction information of each user. Examples of such a function include a color printing function, a function of designating single-sided/double-sided printing, a layout printing function, a number-of-print-sheet restricting function per user, and the like.

The user account management server 5 holds account information of each user who uses the image forming apparatus 10. The account information includes user authentication information, print-function restriction information and the like. The print-function restriction information is information indicating whether use of each of the functions owned by the image forming apparatus 10 is permitted, prohibited, or enforced. The examples of such functions include the color printing function, the function of designating single-sided/double-sided printing, the layout printing function, the number-of-print-sheet restricting function per user, and the like. When the user account management server 5 receives an acquisition request for user account information from the image forming apparatus 10 via the network 3, the user account management server 5 transmits, to the transmission source of the request, the account information including print-function restriction information of a requested user.

The Web server 7 performs a function of transmitting a HyperText Markup Language (HTML) document or a file designated by a uniform resource locator (URL) in response to a Web connection request from an external communication device via the network 3.

The image forming apparatus 10 includes a network interface 11, a browser 12, an operation panel 13, an analyzer 14, a print setting determination part 17, a print controller 18, a user account controller 19, an image forming part 21, and the like. The browser 12 performs a function as a document acquisition part 15.

The image forming apparatus 10 includes a control circuit including, as main parts, a central processing unit (CPU), a read only memory (ROM), a random access memory (RAM), and the like. The respective functions such as the analyzer 14, the browser 12, the document acquisition part 15, the print setting determination part 17, the print controller 18, and the user account controller 19 are implemented by the CPU executing a program stored in the ROM or the like. Additionally, the CPU controls behavior in each of the network interface 11, the operation panel 13, and the image forming part 21 in accordance with programs stored in the ROM or the like.

The network interface 11 performs a function of communicating with the user account management server 5, the Web server 7, and other external devices via the network 3. The operation panel 13 performs a function as a display part that displays various kinds of operation screens, setting screens, and the like, and also performs a function as an operation part that receives various kinds of operation from a user. The operation panel 13 includes a liquid crystal display, various kinds of hard keys such as a start button and a numeric keypad, a touch screen provided on a display surface of the liquid crystal display, and the like.

The image forming part 21 performs a function of forming (printing) an image based on image data on a recording sheet. Here, the image forming part 21 includes a recording sheet conveying device, a photoreceptor drum, a charging device, a laser unit, a developing device, a transfer-separation device, a cleaning device, and a fixing device, and is formed as an engine part of a so-called laser printer that executes image formation by an electrophotographic process. Another method may also be used for image formation.

In a case where the user account controller 19 receives log-in operation from a user via the operation panel 13 or the like, the user account controller 19 transmits the acquisition request for user account information to the user account management server 5 and acquires, from the user account management server 5, the account information of the log-in user. The user account controller 19 performs a function as a restriction information acquisition part that acquires print-function restriction information of the log-in user.

The browser 12 is a so-called Web browser, and performs functions of: transmitting a service request to an external server such as the Web server 7; displaying, on the display part of the operation panel 13, an HTML document transmitted from the server in response to the service request; transmitting a new service request in response to user's operation received on a screen displayed based on the HTML document; and executing a program embedded in the HTML document. The browser 12 performs a function as the document acquisition part 15 that acquires an HTML document or downloads a file from the server.

Note that the operation panel 13 that currently displays a HTML document in response to a command from the browser 12 functions as a print command receiver that receives, from a user, a print command for the HTML, document currently displayed or receive a command to download and print a file linked to the HTML document.

The analyzer 14 analyzes whether any designated print setting information is included in the HTML document currently displayed on the operation panel 13. The designated print setting information provides a command to print, with a predetermined print setting, a print object (the HTML document or the file linked to the HTML document) associated with the print command.

In a case where an analysis result of the analyzer 14 indicates that the designated print setting information is included in the HTML, document, the print setting determination part 17 performs a function of determining, in accordance with the designated print setting information, a print setting at the time of printing the print object (the HTML document or the file linked to the HTML document) associated with the print command. In a case where an analysis result of the analyzer 14 indicates that the designated print setting information is not included in the HTML document, the print setting determination part 17 performs a function of determining a print setting in accordance with print-function restriction information included in the account information acquired by the user account controller 19 (more specifically, based on the print setting designated by a user from the operation panel 13 or the like, and the print-function restriction information).

The print controller 18 performs a functions of: generating raster data by executing RIP processing or the like in accordance with the print setting determined by the print setting determination part 17; and outputting the raster data to the image forming part 21. The image forming part 21 executes printing based on the raster data received from the print controller 18. The print controller 18 and the image forming part 21 cooperatively perform a function as a print execution part.

Next, behavior of the image forming apparatus 10 at the time of printing an HTML document (or a file linked to the HTML document) based on a print command from a user will be described.

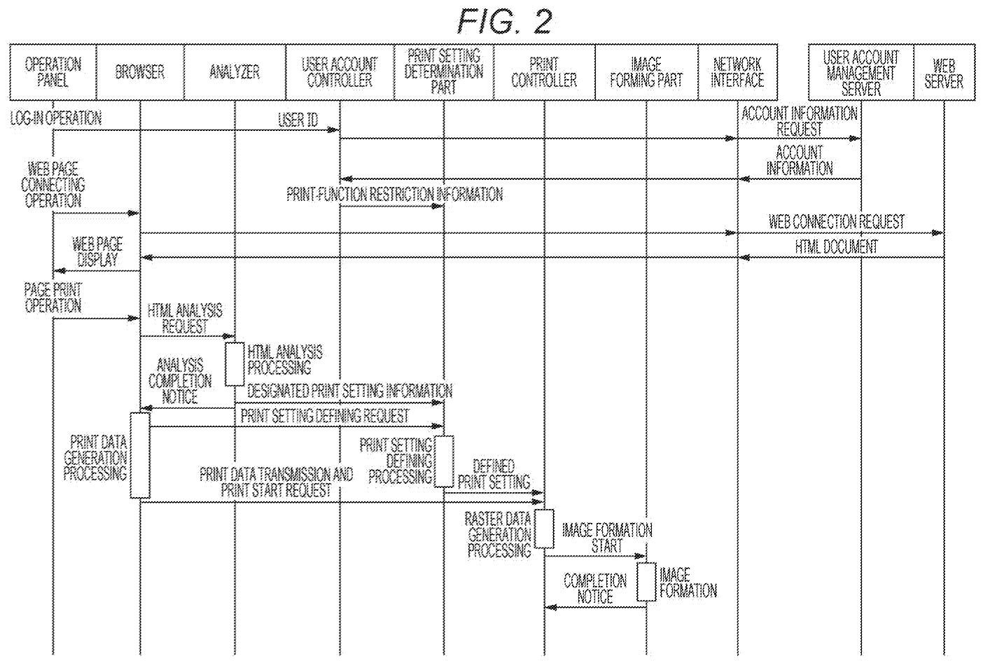

FIG. 2 illustrates a print sequence in the case where designated print setting information is included in the HTML document. When the designated print setting information is included in the HTML document, the print-function restriction per user is released, and the HTML document or the like is printed with a print setting conforming to the designated print setting information included in the HTML document.

First of all, the image forming apparatus 10 receives log-in operation from a user on the operation panel 13. The user account controller 19 receives, from the operation panel 13, a user ID that has been input when the user executed the log-in operation on the operation panel 13, and transmits an acquisition request for account information designating the user ID to the user account management server 5 via the network interface 11 and the network 3.

The user account management server 5 returns the account information corresponding to the designated user ID to the image forming apparatus 10 that is a transmission source of the acquisition request for the account information.

The user account controller 19 extracts the print-function restriction information from the account information acquired from the user account management server 5, and transmits the print-function restriction information to the print setting determination part 17.

After that, the user performs Web page connecting operation on the operation panel 13. The operation panel 13 that has received the operation notifies the browser 12 of this operation. The browser 12 transmits a Web connection request to the Web server 7 via the network interface 11 and the network 3 from a URL input by the above operation or a URL designated by the operation and preliminarily registered in the browser 12. Then, an HTML, document designated by the URL is acquired from the Web server 7, and a Web page based on the HTML document is displayed on the operation panel 13.

The Web page displayed on the operation panel 13 includes a button that provides a command to print the Web page or a link used for downloading a file on the Web server. When a command to print the Web page or download to print a file at a link destination is received from the user through the operation panel 13, the browser 12 transmits an HTML analysis request to the analyzer 14. When such a request is received, the analyzer 14 executes processing (HTML analysis processing) to check whether any designated print setting information that designates a print setting is included in the HTML document that is the source of the Web page currently displayed on the operation panel 13. In a case where the designated print setting information is included in the HTML document, the analyzer 14 transmits the designated print setting information to the print setting determination part 17. After completion of the HTML analysis processing, the analyzer 14 transmits an analysis completion notice to the browser 12.

In the HTML, analysis processing, for example, in a case where an HTML document acquired from the Web server 7 includes a data attribute (attribute portion) in order to designate a predetermined print setting and a valid value is set, the analyzer 14 extracts the setting value and transmits the setting value to the print setting determination part 17 as the designated print setting information. In a case where no valid value is set, the analyzer 14 determines that no designated print setting information is included in the HTML document.

The HTML analysis processing is not limited thereto. For example, the designated print setting information may be included in a body part (so-called body) of an HTML document, and may also be included in an image (for example, a two-dimensional barcode image) in an HTML document. The HTML analysis processing extracts and analyzes the designated print setting information included in any of such forms.

When the analysis completion notice is received from the analyzer 14, the browser 12 transmits a print setting defining request to the print setting determination part 17, and also generates print data to print the Web page currently displayed. Then, the browser 12 transmits the print data and a print start request to the print controller 18. Meanwhile, in a case of receiving a print command in which a file at a link destination is set as a print object, the file is requested to the Web server 7 and downloaded, and then the file and the print start request are transmitted to the print controller 18.

In a case where the print setting (here, panel print setting information) set by user's operation on the operation panel 13 is transmitted from the browser 12, the print setting determination part 17 receives and holds the print setting. In a case where the designated print setting information is transmitted from the analyzer 14, the print setting determination part 17 receives and holds the designated print setting information. In a case where the print-function restriction information is transmitted from the user account controller 19, the print setting determination part 17 receives and holds the print-function restriction information.

When the print setting defining request is received from the browser 12, the print setting determination part 17 executes print setting defining processing, and transmits the defined print setting to the print controller 18. In the example of FIG. 2, since the designated print setting information received from the analyzer 14 is held when the print setting defining request is received from the browser 12, the print setting conforming to the designated print setting information is determined as the defined print setting, and the defined print setting is transmitted to the print controller 18.

After reception of the print data and the print start request from the browser 12, the print controller 18 generates raster data, for print output in accordance with the defined print setting received from the print setting determination part 17, and transmits the raster data to the image forming part 21. The image forming part 21 transfers color materials onto a print medium to form an image in accordance with the received raster data, and when the image formation is completed, the image forming part 21 transmits a print completion notice to the print controller 18.

Thus, when the print command in which the HTML document or the file linked to the HTML document is set as the print object is received, in the case where the designated print setting information is included in the HTML document, the print-function restriction per user is: automatically released. Then, the print object is printed with the print setting conforming to the designated print setting information.

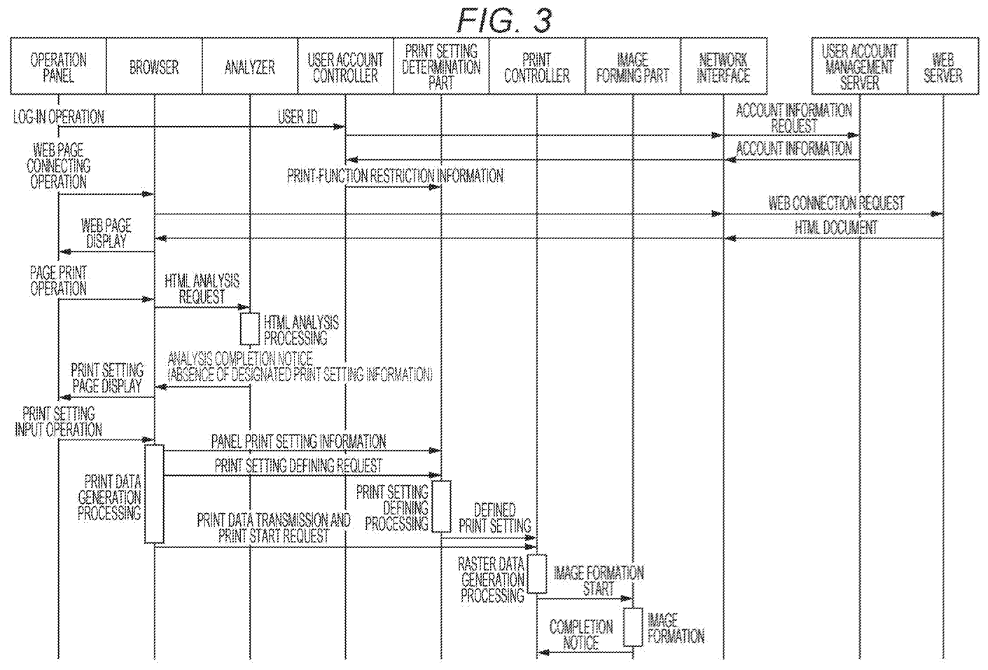

FIG. 3 illustrates a print sequence in the case where designated print setting information is not included in the HTML document. In the case where the designated print setting information is not included in the HTML document, the print-function restriction per user is enabled, and the HTML document or the like is printed with the print setting in which the function is restricted in accordance with print function restriction information of a log-in user.

A flow until reception of page print operation from the user is the same as that in FIG. 2, and therefore, the description thereof will be omitted. When the page print operation is received, the browser 12 transmits an HTML analysis request to the analyzer 14. The analyzer 14 that has received the request executes the processing (HTML analysis processing) to check whether any designated mint setting information is included in the HTML document that is a source of a Web page currently displayed on the operation panel 13. In the case where the designated print setting information is not included in the HTML document, the analyzer 14 transmits, to the browser 12, an analysis completion notice including content that indicates that the designated print setting information is not included.

In the case where the designated print setting information is not included in the analysis completion notice received from the analyzer 14, the browser 12 displays, on the operation panel 13, a page (print setting input screen) that urges the user to input a print setting.

When input operation of the print setting is received from the user on the operation panel 13, the browser 12 transmits the input print setting to the print setting determination part 17 as the panel print setting information, and further consecutively transmits a print setting defining request to the print setting determination part 17. Additionally, print data used to print the Web page currently displayed is generated, and the print data and, a print start request are transmitted to the print controller 18. Meanwhile, in a case where a print command for a file at a link destination is received, a request for the file is sent to the Web server 7 to download the file, and the file and the print start request are transmitted to the print setting determination part 17.

When the print setting defining request is received from the browser 12, the print setting determination part 17 executes the print setting defining processing and transmits the defined print setting to the print controller 18.

In the example of FIG. 3, when the print setting defining request is received from the browser 12, the designated print setting information is not received from the analyzer 14, and the panel print setting information received from the browser 12 and the print-function restriction information received from the user account controller 19 are held. Therefore, the print setting indicated by the held panel print setting information is subjected to function restriction in accordance with the held print-function restriction information to obtain a print setting. The print setting thus obtained is determined as the defined mint setting and transmitted to the print controller 18. Subsequent processing is the same as that in FIG. 2, and the description thereof will be omitted.

Thus, according to the image forming apparatus 10 according to the first embodiment of the present invention, in the case where the designated print setting information is included in the HTML document, the print-function restriction per user is automatically released and the print setting conforming to the designated print setting information is adopted. Therefore, as for a document to be printed with a print setting designated by a document issuer, the print-function restriction per user can be simply and automatically released and can be printed with the designated print setting only by the HTML document including the designated print setting information.

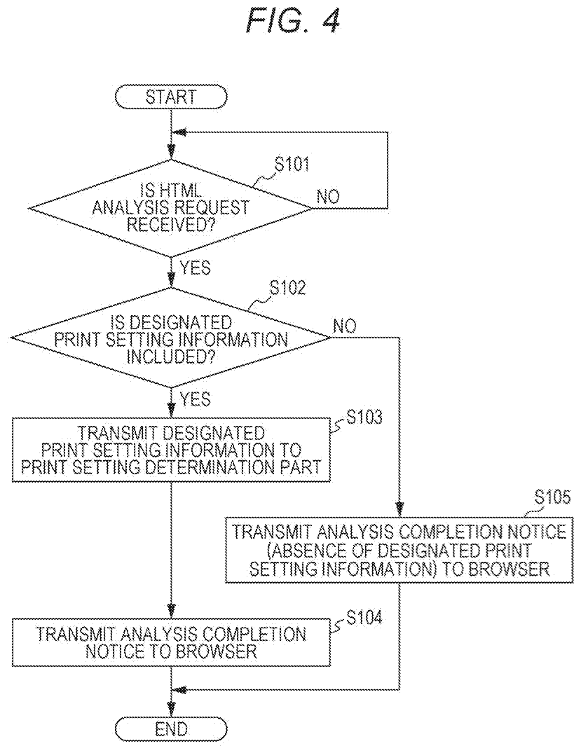

FIG. 4 is a flowchart illustrating the HTML analysis processing performed by the analyzer 14. When an HTML analysis request is received (step S101; Yes), the analyzer 14 analyzes an HTML document and determines whether any designated print setting information is included in the HTML document (step S102). In the case where the designated print setting information is included, the designated print setting information is extracted from the HTML document and transmitted to the print setting determination part 17 (step S103). After that, an analysis completion notice is transmitted to the browser 12 (step S104), and the processing ends.

In the case where the designated print setting information is not included (step S102; No), an analysis completion notice indicating absence of the designated print setting information is transmitted to the browser 12 (step S105), and the processing ends.

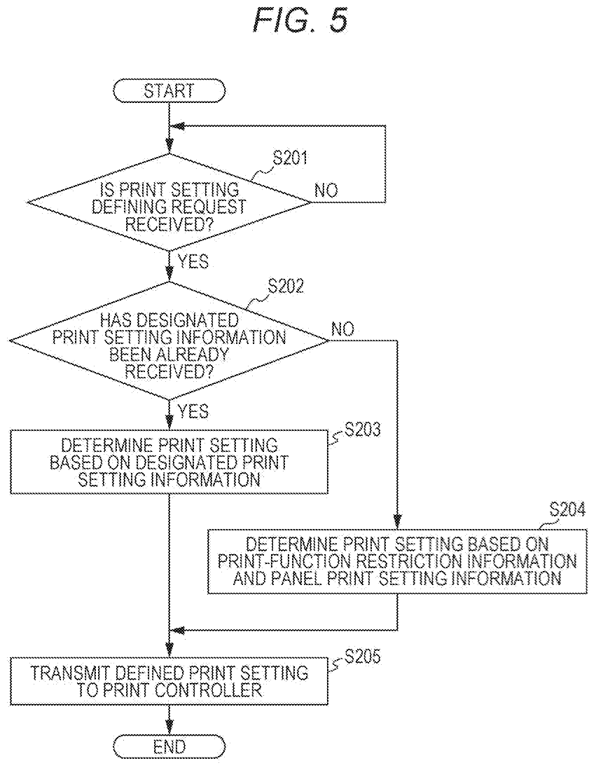

FIG. 5 is a flowchart illustrating the print setting defining processing performed by the print setting determination part 17. When a print setting defining request is received from the browser 12 (step S201; Yes), the print setting determination part 17 checks whether the designated print setting information has been already received and held (step S202). In the case Where the designated print setting information has been received and held (step S202; Yes), a print setting is determined in accordance with the designated print setting information (step S203), and this print settings transmitted to the print controller 18 as the defined print setting (step S205). Then, the processing ends.

In the case where the designated print setting information has not been received (held) (step S202; No), a print setting indicated by the panel print setting information is subjected to function restriction in accordance with the print-function restriction information to determine a print setting (step S204), and this print setting is transmitted as the defined print setting to the print controller 18 (step S205). Then, the processing ends.

Next, a description will be provided for a case where the number of print sheets and the number of printable sheets per user are managed by the number-of-print-sheet restricting function.

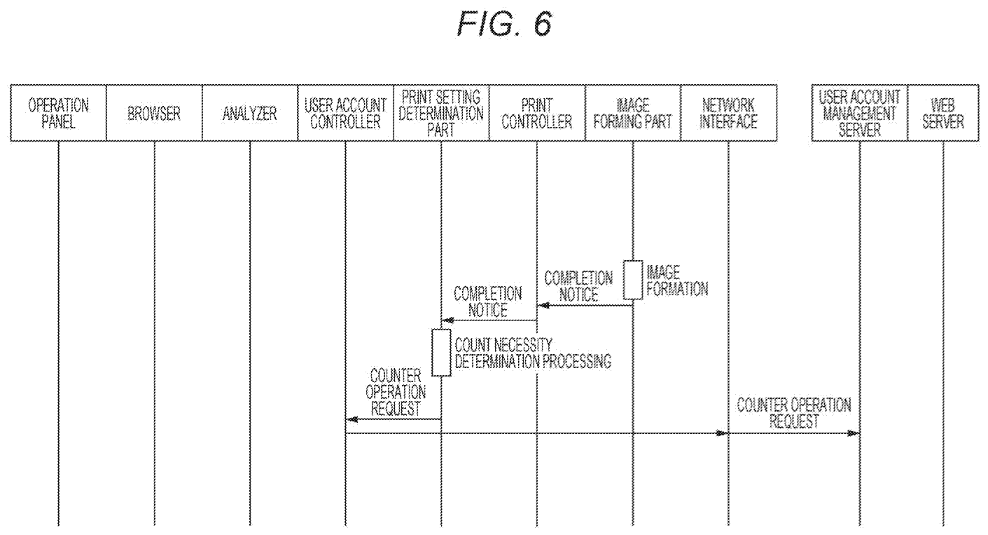

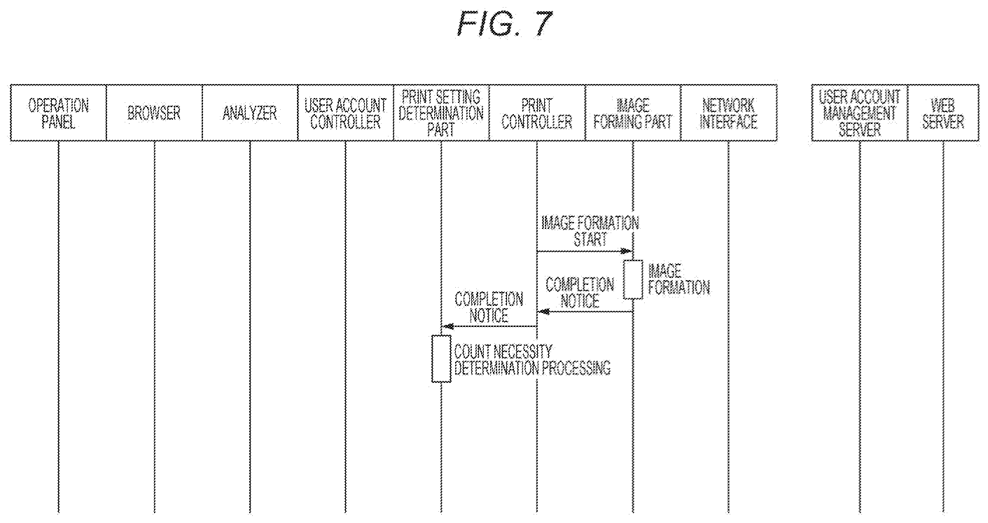

FIG. 6 is a sequence diagram illustrating behavior in a case where the number-of-print-sheet restricting function is enabled. FIG. 7 is a sequence diagram illustrating behavior in a case where the number-of-print-sheet restricting function is disabled. The print setting determination part 17 disables the number-of-print-sheet restricting function in a case where designated print setting information is included in an HTML document, in other words, in regard to printing performed with a print setting conforming to the designated print setting information. Each of FIGS. 6 and 7 illustrates the print sequence after the image forming part 21 completes image formation and transmits a completion notice to the print controller 18. The behavior therebefore is the same as that in each of FIGS. 2 and 3.

After receipt of the completion notice of the image formation from the image forming part 21, the print controller 18 transmits the completion notice to the print setting determination part 17. The print setting determination part 17 that has received the completion notice from the print controller 18 executes processing (count necessity determination processing) to check whether the number-of-print-sheet restricting function is enabled or disabled.

For example, in a case where a print setting currently executed is not determined in accordance with the designated print setting information (in a case where the print setting determination part 17 does not hold the designated print setting information), the print setting determination part 17 determines that the number-of-print-sheet restricting function is enabled, and transmits, to the user account controller 19, a counter operation request including the number of print sheets in the printing executed this time, as illustrated in FIG. 6.

The user account controller 19 that has received the counter operation request adds a user ID to the counter operation request, and transmits the request to the user account management server 5 via the network interface 11. The user account management server 5 updates a counter by performing addition/subtraction with the number of print sheets included, in the received, counter operation request. The counter counts the number of print sheets or the number of printable sheets of a user corresponding to the received user ID.

In a case where the printing currently executed is executed with the print setting conforming to the designated print setting information (in the case where the print setting determination part 17 holds the designated print setting information), the print setting determination part 17 determines that the number-of-print-sheet restricting function is disabled, and does not transmit the counter operation request to the user account controller 19, as illustrated in FIG. 7.

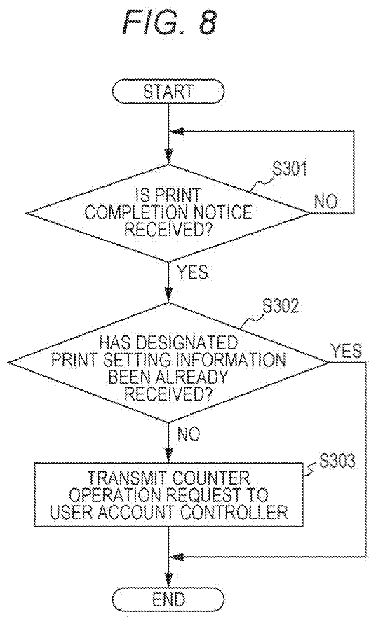

FIG. 8 is a flowchart illustrating a count necessity determination processing performed by the print setting determination part 17. When the print completion notice is received from the print controller 18 (step S301; Yes), whether the designated print setting information has been already received from the analyzer 14 and is held (whether current printing is performed with the print setting conforming to the designated print setting information) is checked (step S302). In the case where the designated print selling information is not held (in the case where the current printing is not performed with the print setting conforming to the designated print setting information) (step S302; No), it is determined that the number-of-print-sheet restricting function is enabled, and the counter operation request including the current number of print sheets is transmitted to the user account controller 19 (step S303).

On the other hand, in the case where the designated print setting information is held (in the case where the current printing is performed with the print setting conforming to the designated print setting information) (step S302; Yes), it is determined that the number-of-print-sheet restricting function is disabled, the processing ends without transmitting the counter operation request to the user account controller 19.

As described above, in the case where the printing is executed with the print setting conforming to the designated print setting information, the number-of-print-sheet restricting function per user is automatically disabled, and the number of print sheets printed with the print setting conforming to the designated print setting information is automatically excluded from a count target of the number of print sheets or the number of printable sheets of a log-in user associated with the number-of-print-sheet restricting function.

### Second Embodiment

In a first embodiment, in a case where designated print setting information is included in an HTML document, a defined print setting is determined in accordance with the designated print setting information, whereas in a second embodiment, a condition to determine a defined print setting in accordance with designated print setting information additionally includes a condition that a predetermined release code is included in an HTML document. In other words, in a case where the designated print setting information and the predetermined release code are included, in the HTML document, an analyzer 14 outputs the designated print setting information to a print setting determination part 17. The rest is similar to the first embodiment.

Since the designated print setting information can be included in the HTML document by any person, only designated print setting information set by a person who knows the predetermined release code is determined as valid. Thus, security against releasing print-function restriction is ensured.

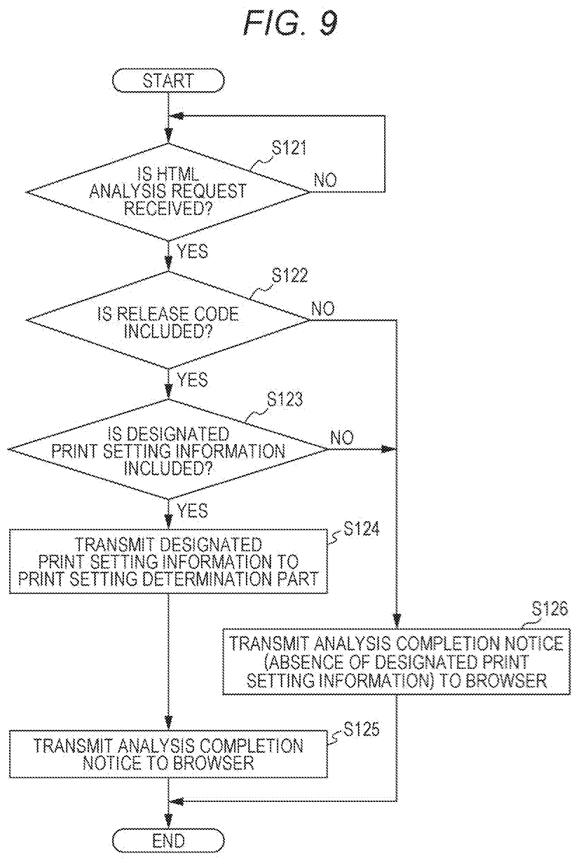

FIG. 9 is a flowchart illustrating HTML analysis processing performed by the analyzer 14 according to the second embodiment. When an HTML analysis request is received from a browser 12 (step S121; Yes), the analyzer 14 checks whether a release code same as the predetermined release code held by the analyzer 14 in advance is included in an HTML document (step S122). In a case where the release code (valid release code) same as the predetermined release code is included in the HTML document (step S122; Yes), whether designated print setting information is included in the HTML document is determined (step S123). In a case where the designated print setting information is included (step S123; Yes), the designated print setting information is extracted from the HTML document and, transmitted to the print setting determination part 17 (step S124). After that, an analysis completion notice is transmitted to the browser 12 (step S125), and the processing ends.

In a case where the release code (valid release code) same as the predetermined release code is not included in the HTML document (step S122; No) and in a case where the designated print setting information is not included in the HTML document (step S123; No), an analysis completion notice indicating absence of the designated print setting information is transmitted to the browser 12 (step S126). Then, the processing ends.

### Third Embodiment

In a first embodiment, in a case where designated print setting information is included in an HTML document, a defined print setting is determined in accordance with the designated print setting information, whereas in a third embodiment, a condition to determine a defined print setting in accordance with designated print setting information additionally includes a condition that an acquisition source of an HTML document is a preset server. In other words, in a case where the acquisition source of the HTML document is the preset server and the designated print setting information is included in the HTML document, an analyzer 14 outputs the designated print setting information to a print setting determination part 17. Note that a condition that a release code is included may also be additionally included.

Since the designated print setting information can be included in the HTML document by any person, only in the case where the acquisition source of the HTML document is the preset server, the designated print setting information is determined as valid. Thus, security against releasing print-function restriction is ensured.

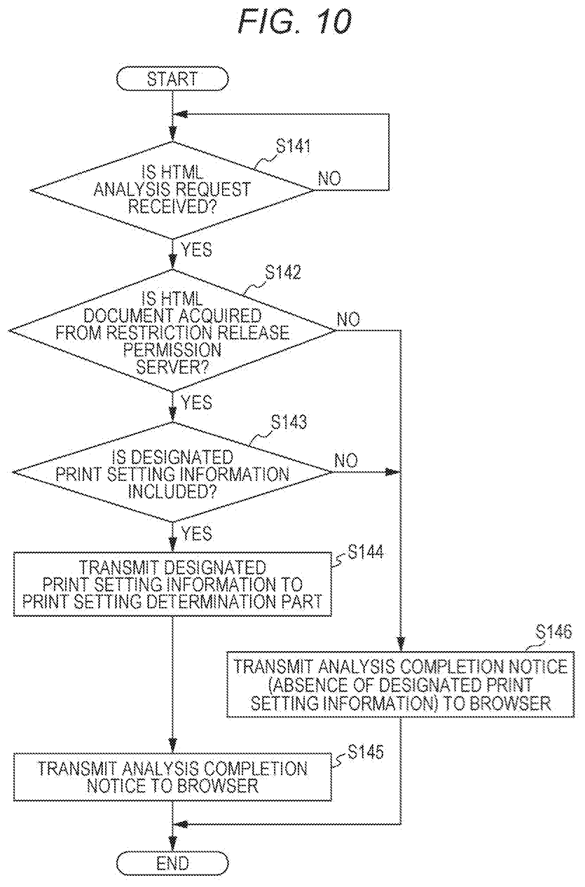

FIG. 10 is a flowchart illustrating HTML analysis processing performed by the analyzer 14 according, to the third embodiment. When an HTML analysis request is received from a browser 12 (step S141; Yes), the analyzer 14 checks whether a Web server that is an acquisition source of an HTML document to be analyzed is included in restriction release permission server information (a list in which restriction release permission servers are registered) held by the analyzer 14 in advance (step S142). In a case where the Web server that is the acquisition source of the HTML document to be analyzed coincides with any server listed in the restriction release permission server information (step S142; Yes), whether designated print setting information is included in the HTML, document is determined (step S143). In a case where the designated print setting information is included (step S143; Yes), the designated print setting information is extracted from the HTML, document and transmitted to the print setting determination part 17 (step S144). After that, an analysis completion notice is transmitted to the browser 12 (step S145), and the processing ends.

In a case where the Web server that is the acquisition source of the HTML document to be analyzed does not coincide with any server listed in the restriction release permission server information (step S142; No) and in a case where the designated print selling information is not included in the HTML document (step S143; No), an analysis completion notice indicating absence of the designated print setting information is transmitted to the browser 12 (step S146). Then, the processing ends.

In the above, the embodiments of the present invention have been described with reference to the drawings. However, a concrete configuration is not limited to those illustrated in the embodiments, and any modification and addition made within the scope not departing from the gist of the present invention is to be included in the present invention.

In the embodiments, the print-function restriction information per user is acquired from the user account management server 5 connected via the network 3. However, the method of acquiring the print-function restriction information is not limited thereto. The print-function restriction information per user may be registered and managed in the image forming apparatus 10, and the print-function restriction information of the corresponding user may be acquired by referring thereto.

In a case of downloading a file linked to an HTML document, the file may be moved to a different page (such as a download-only page) from the HTML document and then downloaded from the page to which the file has been moved. In this case, what required is to determine whether the designated print setting information is included in a target page (HTML document) immediately before the downloading.

The functions to be restricted (the use thereof is to be permitted, prohibited, or enforced) by the print-function restriction function are not limited to those exemplified in the embodiments, and may include an arbitrary function owned by the image forming apparatus 10.

In the embodiments, in the case where the designated print setting information is included, the number-of-print-sheet restricting function is disabled. However, the number-of-print-sheet restricting function may also be disabled on the condition that information that disables the number-of-print-sheet restricting function is included in the designated print setting information.

The present invention may include a program that controls behavior of the image forming apparatus 10, in addition to the image forming apparatus 10.

The image forming apparatus 10 may be a multifunction machine having functions such as copying, scanning, and fax transmission/reception besides the printing function.

Although embodiments of the present invention have been described and illustrated in detail, the disclosed embodiments are made for purposes of illustration and example only and not limitation. The scope of the present invention should he interpreted, by terms of the appended claims.

What is claimed is:

1. An image forming apparatus comprising:
a restriction information acquisition part that acquires print-function restriction information corresponding to a user;
a document acquisition part that acquires an HTML document from a Web server;
a print command receiver that receives a print command in which an HTML document acquired by the document acquisition part or a file linked to the HTML document is set as a print object;
an analyzer that analyzes whether designated print setting information is included, in the HTML document, the designated print setting information providing a command to print, with a predetermined print setting, the print object associated with the print command;
a print setting determination part, in which in a case where an analysis result of the analyzer indicates that the designated print setting information is included in the HTML document, the print setting determination part determines, in accordance with the designated print setting information, a print setting at the time of printing the print object associated with the print command, and in a case where an analysis result of the analyzer indicates that the designated print setting information is not included in the HTML document, the print setting determination part determines the print setting in accordance with the print-function restriction information corresponding to the user; and
a print execution part that prints, in accordance with the print setting determined by the print setting determination part, the print object for which the print command has been received.

2. The image forming apparatus according to claim 1, wherein the print function restriction information includes at least one of permission for use, prohibition of use, and enforced use of at least one of a color printing function, a function of designating single-sided/double-sided printing, a layout printing function, and a number-of-print-sheet restricting function per user.

3. The image forming apparatus according to claim 1, wherein the print setting determination part disables a number-of-print-sheet restricting function per user in regard to printing performed with a print setting conforming to the designated print setting information.

4. The image forming apparatus according to claim 1, wherein in a case where both a predetermined release code and the designated print setting information are included in the HTML document acquired by the document acquisition part, the analyzer outputs an analysis result indicating that the designated print selling information is included.

5. The image forming apparatus according to claim 1, wherein in a case where an acquisition source of the HTML document is a preset server and the designated print setting information is included in the HTML document, the analyzer outputs an analysis result indicating that the designated print setting information is included.

6. The image forming apparatus according to claim 1, wherein the designated print setting information is included in an attribute portion inside the HTML document, included in a body part inside the HTML document, or included in an image inside the HTML document.

7. A non-transitory recording medium storing a computer readable program executed by a hardware processor that controls behavior of an image forming apparatus, wherein
the image forming apparatus is made to function as the image forming apparatus according to claim 1.
